(19) United States
(12) Patent Application Publication
(10) Pub. No.: US 2011/0135777 A1
(43) Pub. Date: Jun. 9, 2011

(54) METHOD AND DEVICE FOR CREATIVE ART USING NYLON OR PLASTIC WASTE

(76) Inventor: Vered Hadad, Abu Gosh (IL)

(21) Appl. No.: 13/031,218

(22) Filed: Feb. 20, 2011

Related U.S. Application Data
(63) Continuation of application No. 12/133,417, filed on Jun. 5, 2008, now abandoned.
(60) Provisional application No. 60/933,856, filed on Jun. 11, 2007.

(51) Int. Cl. B29C 59/02

(52) U.S. Cl. 425/318

(57) ABSTRACT

Apparatus for forming a plastic material, the apparatus comprising: a brush head comprising a first set of heat conductive bristles interleaved with a second set of bristles; a handle that holds the brush head so that the brush head may be manually manipulated; and a heating element that heats the first set of bristles to a temperature sufficient to heat a plastic material by contact with the brush head to a temperature at which the plastic material is formable responsive to manual manipulation of the brush head.

### CROSS REFERENCE TO RELATED APPLICATIONS

This application is a continuation of U.S. application Ser. No. 12/133,417, filed Jun. 5, 2008, which claims benefit under 35 U.S.C. §119(e) of U.S. Provisional Application No. 60/933,856 filed Jun. 11, 2007.

### FIELD OF THE INVENTION

This invention is in the field of art and in particular using a device for melting nylon or plastic and using them as raw materials for creative art, the nylon or plastic might be recycled or “new”.

### BACKGROUND OF THE INVENTION

Art is a flexible field where the artist is free to use his imagination and skills to produce an effect that is pleasing and/or meaningful to the beholder or to the intended audience. Plastic or nylon and more specific nylon bags are a widely used commodity in every-day life but when disposed of, can cause damage to the environment when thrown into the garbage together with decomposable waste products. This is especially so when the garbage is burned. Any use of such used plastic products that reduces their presence at garbage dumps is a positive contribution to the environment.

This invention uses waste plastic products to produce creative art. The source of the plastic does not have to be used or second hand plastic but economic or convenience considerations may encourage the use of used plastic.

The invention also reveals instruments to aid the application of the plastic products to the desired surface used.

### SUMMARY OF THE INVENTION

It is to be understood that both the foregoing general description and the following detailed description present embodiments of the invention and are intended to provide an overview or framework for understanding the nature and character of the invention as it is claimed.

This invention reveals a way of using nylon or plastic materials for creative art by using a device that heat the nylon or plastic materials up to a degree of melting part or all of the materials and attaching them on a desired surface creating drawings or sculptures with different depths and or three dimensions forms.

The nylon or plastic used can be plastic bags or plastic vessels of various types, thicknesses and colors, used or unused according to the choice of the user. The most preferred raw material would be the common thin plastic bags. The nylon or plastic materials used by this invention for creative art are herein referred to as the raw materials. The device could be shaped as a paintbrush and would include heat conductor that leads heat to the surface that come in contact with the raw material, up to a degree that would melt the raw material in the place that came in touch with the heat conductor. The head of brush might include also a further material suitable for adjusting and directing the melted or partially melted plastic or nylon on the desired surface.

Suitable surface for such drawings would be any other nylon or plastic materials, as for example stronger nylon bags and plastic dishes, or even any regular canvas. It is also optional to use the raw materials on other raw materials without using flat surface and to create different three dimensions forms as for example pillows, curtain, bags or any other desired form or sculptures with different depths and or three dimensions forms.

The heating conductor might be metallic, as for example cooper, bristles as of a brush type of design.

The head of the brush might have different shapes and sizes with different qualities as for example be stronger, more flexible, wider, sharper and the like, for different applications of the raw materials on different desired surface.

The device might come with an attached and removable head of brush and even might come with few different shapes of heads of brush so the user might change the head of brush according to his desired type of application of the raw materials on the desired surface.

The melting of the raw materials for creating art by the device described above would be externally, the raw materials would be placed on the surface where the picture or sculpture is being made and the device would be used as a paint brush for both melting the raw materials and adjusting and fixing the melted or partially melted raw materials in the desired creative way.

Alternatively the melting of the raw materials might be internally to the device. The device might be designed in a shape of a hand gun, the device would have an entrance for the raw material, to be placed in a tube with a nozzle on its end, and a trigger to push the raw material through the nozzle. The heating elements would be around the tube so the melting or partially melting of the raw materials would be inside the tube.

The nozzle of the internal melting device or the head of the brush on the external melting device might be of various shapes and sizes to assist the application of the melted or partially melted plastic or nylon onto the desired surface. Both instruments would have energy source as battery or connection to an electric source for operating the heating elements to melt or partially melt the plastic.

A new method of drawing is also revealed by this invention. The user has the option after drawing with the raw materials on a surface of a stronger nylon for example to gently separate the new drawing from its original surface so the user would get a new drawing from nylon or plastic existing by itself with no surface to hold it. Such drawing would be flexible but strong enough to be hanged or presented by itself with no surface underneath.

### BRIEF DESCRIPTION OF THE DRAWINGS

The accompanying drawings are included to provide a further understanding of the invention and are incorporated into and constitute a part of this specification. The drawings illustrate various embodiments of the invention and, together with the description, serve to explain the principles and operations of the invention, by way of example only and not to limit the invention to these descriptions only.

FIG. 1 is a schematic description of a device for creative art using nylon or plastic materials by externally melting the nylon or plastic materials and applying them on a desired surface.

FIG. 2 is a schematic description of different kind of heads of brush.

FIG. 3 is a schematic description of a device for creative art using nylon or plastic materials by internally melting the nylon or plastic materials and applying them on a desired surface.

FIG. 4 is the cross section view of the instrument in FIG. 3 showing the position of the heating element.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

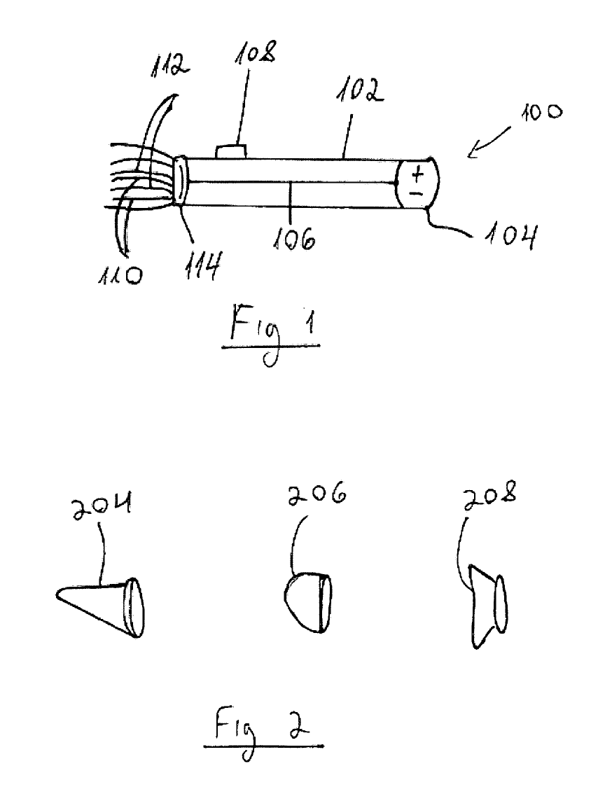

FIG. 1 shows a device 100 enabling a method for creative art using nylon or plastic materials by externally melting and applying them on other nylon, plastic, canvas or any other surface. The device 100 might be in a shape of a paint brush. The handle 102 has a connection to electric power 104, mains or battery, connecting to a heat conductor 106 that leads the heat to the head of the brush 110, to the surface that come in contact with the raw materials. The heat would be up to a degree that would melt or partially melt the raw materials. There is an operating switch 108 for the user to control the electric current as well as being an on/off switch.

The head of the brush would also include a material 112 suitable for applying the melted or partially melted plastic or nylon in a desired designed by adjusting and attaching them to the desired surface. The heat conductor 110 and the applying material 112 might be placed as bristles of a brush set alternately, so one bristle would be the heat conductor material 110 and the next bristle on line would be the applying material 112.

Suitable material for the heat conductor 110 might be any metal as for example cooper, and the applying material 112 might be any material that would not be affected from the heat of the heating conductor and would be strong enough for adjusting the melted or partially melted plastic or nylon in the desired way and attaching it to the nylon, plastic, canvas or any other surface.

The device might include connecting means 114 to attach and remove the head of brush from the device. The connecting means might be by way of screwing for example, so the user might change the head of brush according to his desired type of application of the raw materials on the desired surface.

FIG. 2 shows different kind of heads of brush that the user would be able to chose from and connect to the device according to the type of application he desired.

The head of the brush might be of various shapes and sizes, for example the head of brush might be very thin 204 for more accurate drawing, more rounded 206 or even flat 208. The applying material might also be of different qualities as for flexibility and hardness to create different applications of the melted plastic or nylon onto the desired surface.

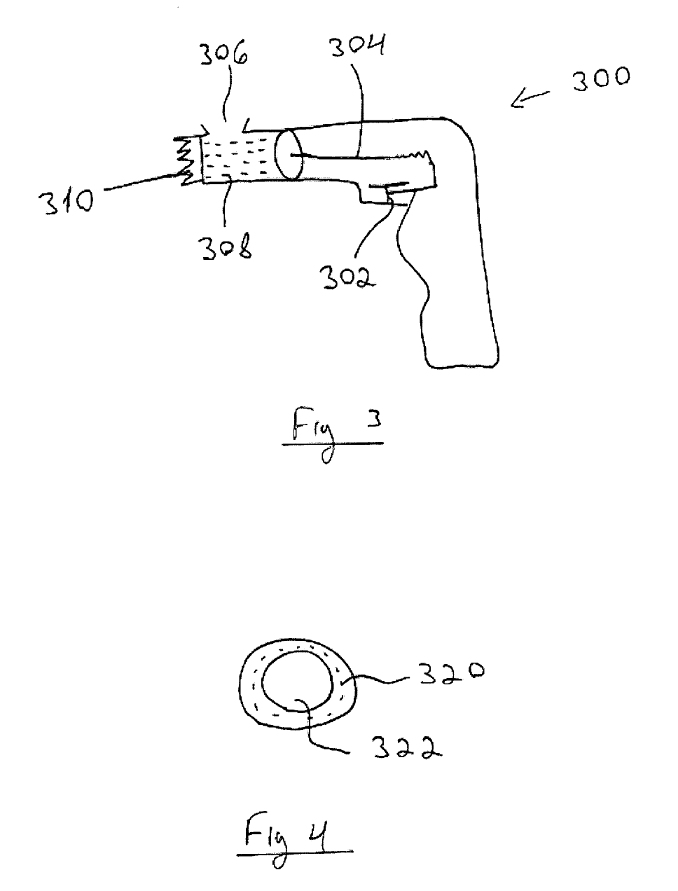

FIG. 3 shows a device 300 for creative art using nylon or plastic materials by internally melting and applying them on other nylon, plastic, canvas or any other surface. There is a trigger 302 that with the aid of leverage or with a spring and ratchet mechanism, pushes the plunger rod 304 forward over the heating elements 308 and out of the exit nozzle 310. There could be many kinds and shapes of nozzle 310 used interchangeably on the melting machine 300.

The release of the trigger 302 brings the plunger 304 back to its original position.

The opening 306 is for entry of raw materials that are desired to be used in the art work. The raw materials could be chosen for their color, texture and content. The plastic or nylon placed in the opening 306 comes in contact with the heat given out by the heating elements 308 and begins to melt, going out through the nozzle and ready to be applied on the desired surface. There is no direct contact between the melting plastic and the heating elements 308. The latter are enclosed around the circumference of the applicator 300 as is shown in FIG. 4.

FIG. 4 shows a section view of the end of the melting machine 300. The heating element 320 is isolated from the internal section 322 of the machine 300 where the plastic is melted.

The present invention is not intended to be limited to the embodiments described above, but to encompass any and all embodiments within the scope of the following claims.

1. Apparatus for forming a plastic material, the apparatus comprising:
a brush head comprising a first set of heat conductive bristles interleaved with a second set of bristles;
a handle that holds the brush head so that the brush head may be manually manipulated; and
a heating element that heats the first set of bristles to a temperature sufficient to heat a plastic material by contact with the brush head to a temperature at which the plastic material is formable responsive to manual manipulation of the brush head.

2. Apparatus according to claim 1 wherein the heat conductive bristles are formed from a metal.

3. Apparatus according to claim 1, wherein the handle and brush head are configured so that the brush head is readily detachable from the handle and replaceable with a different brush head.

4. Apparatus according to claim 1 wherein the temperature is sufficient to cause the plastic material in contact with the brush head to melt.

5. Apparatus according to claim 4 wherein the plastic material comprises plastic material used in the formation of plastic bags.

6. Apparatus according to claim 4 wherein the plastic material comprises nylon.
